(19) United States
(12) Patent Application Publication
(10) Pub. No.: US 2026/0099929 A1
(43) Pub. Date: Apr. 9, 2026

(54) NON-LEARNING BASED SCENE FLOW ESTIMATION USING GRAPH EMBEDDINGS

(71) Applicant: QUALCOMM Incorporated, San Diego, CA (US)

(72) Inventors: Rahul AHUJA, San Diego, CA (US); Varun RAVI KUMAR, San Diego, CA (US); Senthil Kumar YOGAMANI, San Diego, CA (US)

(21) Appl. No.: 18/909,791

(22) Filed: Oct. 8, 2024

(51) Int. Cl. G06T 7/246

(52) U.S. Cl. CPC G06T 7/248; G06T 2207/10028; G06T 2207/20072; G06T 2207/20084

(57) ABSTRACT

Certain aspects of the present disclosure provide techniques for non-learning based scene flow estimation. A method generally includes obtaining a source point cloud comprising a plurality of source points and a candidate point cloud comprising a plurality of candidate points; forming one or more source subgraphs; generating, with a graph neural network (GNN), source vector embeddings; forming one or more candidate subgraphs; generating, with the GNN, candidate vector embeddings; and for each source vector embedding of the source vector embeddings: determining a corresponding matching candidate vector embedding of the candidate vector embeddings based on a comparison of distances between the source vector embedding and each of the candidate vector embeddings; and determining the respective candidate point of the respective candidate subgraph associated with the corresponding matching candidate vector embedding is a respective target point of the respective source point of the respective source subgraph associated with the source vector embedding.

### INTRODUCTION

### Field of the Disclosure

Aspects of the present disclosure relate to scene flow estimation techniques.

### Description of Related Art

Scene flow is the three-dimensional (3D) motion field of a scene. Unlike optical flow, which only captures pixel movement in two-dimensions (2D), scene flow estimation extends this concept to 3D, enabling the precise detection of object trajectories and velocities. Scene flow provides information about the spatial arrangement and rate of change of objects in dynamic environments. Scene flow estimation is a crucial component in the development of autonomous driving and 3D robotics, providing valuable information for environment perception and navigation, including, for example, path planning, obstacle avoidance, and enhancing overall vehicle safety in dynamic environments.

Current supervised learning-based scene flow estimation techniques seek to estimate the scene flow directly from point clouds. However, learning-based scene flow estimation techniques are inherently domain specific and require large datasets of annotated 3D point clouds. The process of annotating 3D data with accurate motion vectors is not only technically challenging but also labor-intensive and costly. This reliance on big, labeled datasets poses a significant barrier, especially for new or unique environments not well-represented in existing data.

Attempts to address the limitation of supervised learning-based scene flow estimation techniques have been made. For example, some unsupervised learning algorithms have been developed for scene flow estimation. Unsupervised algorithms do not require labeled data, reducing dependency on extensive manual annotation and allowing models to learn from raw, unlabeled data directly. These methods can potentially adapt more flexibly to different environments and driving conditions, which is invaluable for autonomous vehicles. However, unsupervised algorithms face their own set of challenges, primarily in establishing accurate point correspondences between consecutive frames, such as between source point clouds corresponding to a first point in time and candidate point clouds corresponding to a subsequent point in time.

Accordingly, there exists a need to develop a scene flow estimation techniques that can provide comparable or better performance than supervised learning-based scene flow estimation techniques without the technical challenges and labor-intensive and costly cultivation of large training datasets of annotated 3D point clouds and which further provide accurate point correspondences between consecutive frames for scene flow estimations.

### SUMMARY

One aspect provides a method for wireless communications by an apparatus. The method includes obtaining a source point cloud comprising a plurality of source points; obtaining a candidate point cloud comprising a plurality of candidate points; forming one or more source subgraphs, wherein each source subgraph of the one or more source subgraphs corresponds to a respective source point in the source point cloud and comprises the respective source point and one or more other source points associated with the respective source point; generating, with a graph neural network (GNN), source vector embeddings, wherein each source vector embedding of the source vector embeddings corresponds to respective source subgraph of the one or more source subgraphs; forming one or more candidate subgraphs, wherein each candidate subgraph of the one or more candidate subgraphs corresponds to a respective candidate point in the candidate point cloud and comprises the respective candidate point and one or more other candidate points associated with the respective candidate point; generating, with the GNN, candidate vector embeddings, wherein each candidate vector embedding of the candidate vector embeddings corresponds to a respective candidate subgraph of the one or more candidate subgraphs; for each source vector embedding of the source vector embeddings: determine a corresponding matching candidate vector embedding of the candidate vector embeddings based on a comparison of distances between the source vector embedding and each of the candidate vector embeddings; and determining the respective candidate point of the respective candidate subgraph associated with the corresponding matching candidate vector embedding is a respective target point of the respective source point of the respective source subgraph associated with the source vector embedding.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative pair of time-gapped frames of a vehicle traversing an environment.

FIG. 2 depicts an illustrative framework for non-learning based scene flow estimation technique.

FIG. 3 depicts an inference framework for the non-learning based scene flow estimation techniques.

FIG. 4 depicts aspects of an example method.

FIG. 5 depicts aspects of an example apparatus for performing the non-learning based scene flow estimation techniques.

### DETAILED DESCRIPTION

Aspects of the present disclosure provide apparatuses, methods, processing systems, and computer-readable mediums for estimating scene flow using unsupervised, non-learning based scene flow estimation technique(s), such as including use of a graph neural network (GNN) based embedding model. For example, the GNN may be a GNNFlow model. Certain aspects provide a non-learning based scene flow estimation technique that is designed to improve correspondence matching in unsupervised scene flow estimation. In certain aspects, such a non-learning based scene flow estimation technique represents a significant step forward in handling the complexities of point cloud data in dynamic scenes.

As discussed herein, scene flow is the three-dimensional (3D) motion field of a scene. Scene flow provides information about the spatial arrangement and rate of change of objects in dynamic environments, which may be a crucial component in the development of autonomous driving and 3D robotics, for example.

Current supervised learning-based scene flow estimation techniques are inherently domain specific and require large datasets of annotated 3D point clouds. The process of annotating 3D data with accurate motion vectors is not only technically challenging but also labor-intensive and costly. This reliance on big, labeled datasets poses a significant barrier, especially for new or unique environments not well-represented in existing data. Additionally, while unsupervised algorithms do not require labeled data, thereby reducing dependency on extensive manual annotation and allowing models to learn from raw, unlabeled data directly, the unsupervised algorithms face their own set of challenges, primarily in establishing accurate point correspondences between consecutive frames, such as between source point clouds corresponding to a first point in time and candidate point clouds corresponding to a subsequent point in time. In some instances, current techniques are unable to address problems such as occlusions, changes in viewpoint, or missing points which complicate the task of reliably matching points across frames. These problems can lead to inaccuracies in flow estimation.

Aspects described herein may overcome the aforementioned technical problems, for example, by providing non-learning based scene flow estimation technique(s) for determining point matching between frames that utilize a GNN. In certain aspects, such a non-learning based scene flow estimation technique described herein provides comparable or better performance than supervised learning-based scene flow estimation techniques without the technical challenges and labor-intensive and costly cultivation of large training datasets of annotated 3D point clouds associated with supervised learning-based scene flow estimation techniques. Additionally, in certain aspects, such a non-learning based scene flow estimation technique can provide accurate point correspondences between time-gapped frames for scene flow estimations. Time-gapped frames refer to data pertaining to different instances of time, for example, a first point cloud obtained at a first point in time defines a first frame and a second point cloud obtained at a second point in time, such as later than the first point in time, defines a second frame.

Certain techniques for scene flow estimation described herein may provide various beneficial technical effects and/or advantages. For example, certain techniques for scene flow estimation described herein may enable improved point correspondence performance for single and multiple modalities. Certain techniques described herein may utilize a graph-based structure that can efficiently encode complex interactions thereby facilitating unsupervised correspondence matching with enhanced efficiency and accuracy.

### Scene Flow Estimation

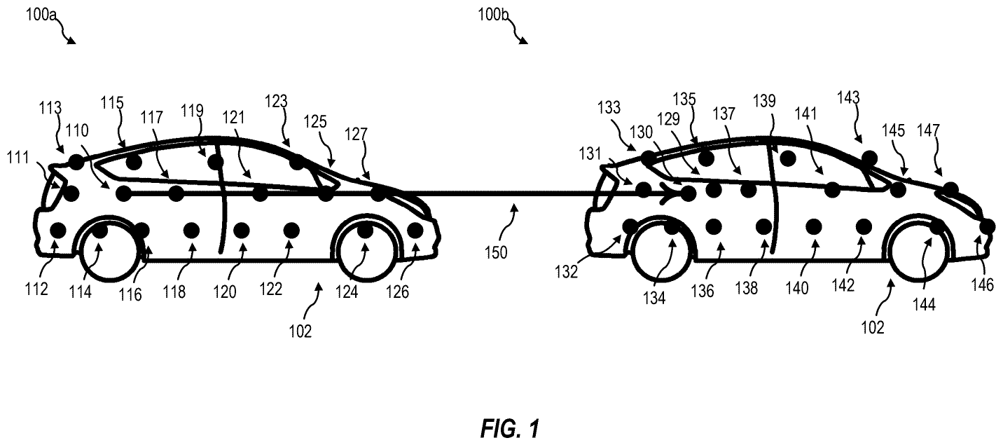

FIG. 1 depicts an illustrative pair of time-gapped frames 100a, 100b of a vehicle 102 traversing an environment. Each of the time-gapped frames 100a, 100b include at least point cloud data corresponding to the respective time-gapped frame 100a, 100b. In some aspects, the time-gapped frame may also include other data such as image data, radar data, or the like. The first time-gapped frame 100a illustratively includes a source point cloud (Pₜ₋₁) comprising a plurality of source points 110-127 {p₁, . . . , p_{N}}. The second time-gapped frame 100b illustratively includes a candidate point cloud (Pₜ) comprising a plurality of candidate points 129-147 {p₁, . . . , p_{N}}.

It is noted that the number of source points and the number of candidate points depicted in the respective time-gapped frames 100a, 100b may be more or less than shown in FIG. 1. This is merely an illustrative example for purposes of explanation.

The object of scene flow estimation is to determine corresponding matching points between the source point cloud and the candidate point cloud. The corresponding matching points may be utilized to compute a flow vector for each pair of corresponding matching points. A flow vector defines the motion, for example, the direction and velocity, of a point from the first point in time to the second point in time. An example flow vector 150 is shown between matching source point 110 and candidate point 120. In some instances, the number of points in the source point cloud and the number of points in the candidate point cloud may be different and there may not be a one-to-one correspondence between the points in each of the point clouds. For example, a first source point 110 does not have a one-to-one correspondence matching point in the candidate point cloud of the second time-gapped frame 100b. For example, in some instances, a point captured in the source point cloud may not have a direct corresponding point in the candidate point cloud. The potential lack of one-to-one correspondence of a point present in the source point cloud but not in the candidate point cloud may arise because the portion of an object associated with the point in the source point cloud is occluded from a sensor's view at the second point in time. In other instances, the lack of one-to-one correspondence of a point present in the source point cloud but not in the candidate point cloud may arise because the sensor configured to obtain the points in the environment may obtain reflections from other portions of the object at the second point in time. As such, grouping nearby points can assist in determining a correspondence to a point in the source point cloud that is not directly represented as a point in the candidate point cloud.

In certain aspects, for example, a source point 110, which may lack a one-to-one correspondence matching, may utilize a flow vector 150 determined from correspondence matching of nearby points to model the motion of the source point 110 into the second point in time, which may give rise to a first candidate source point 130 in the second time-gapped frame 100b. In certain aspects of scene flow estimation, a flow field F having a plurality of flow vectors f may define the respective motion of points from frame to frame.

The scene flow estimation problem may be formulated as an optimization problem that is configured to minimize an equation. For example, in some aspects, the optimization problem may be formulated as show in Equation 1.

$${F}^{*} = a r {g}_{F} min {\sum }_{{{p}_{i} ∈ P}^{} t - 1} d i s t ( {p}_{i} + {f}_{i} , {P}_{t} )$$

Equation 1 is unconstrained. In certain aspects, in order to find accurate correspondences and convergence, non-learning based scene flow estimation techniques discussed herein may be used. For example, in some aspects the optimization problem may be constrained by subgraphs generated by a GNN based embedding model, such as GNNFlow.

### Non-Learning Based Scene Flow Estimation

In certain aspects, a non-learning based scene flow estimation technique as described herein may include obtaining a source point cloud corresponding to a first point in time and a candidate point cloud corresponding to a second (e.g., subsequent) point in time. As discussed in more detail herein, a source subgraph for each point in the source point cloud is generated. The source subgraph for a given point in the source point cloud may incorporate one or more other points associated with (e.g., near, such as within a threshold distance of) the given point in the source point cloud. For example, the one or more other points may be the K-nearest neighbors of the given point in the source point cloud. The term “near” or “nearest” as used herein with reference to a point of the point cloud may refer to points that are within a radius of a respective point or as defined by one or more K-nearest neighbors (KNN) algorithms, such as a machine learning technique that uses proximity to predict the class or value of a data point.

The source subgraph for each point in the source point cloud may then be processed through the GNN based embedding model which is trained to understand and encode the spatial relationships within the point cloud. In certain aspects, each processed source subgraph yields a d-dimensional vector embedding that encapsulates one or more features (e.g., essential features) and/or positional context of the point and its neighbors in the source point cloud. In some cases, the robustness of these embeddings allows for accurate matching across frames, even in the presence of noise and partial data.

A similar process of generating candidate subgraphs for each point in the candidate point cloud and processing the candidate subgraphs through the GNN based embedding model may be carried out. Each of the processed candidate subgraphs yields a d-dimensional vector embedding that encapsulates one or more features (e.g. essential features) and/or positional context of the point and its neighbors in the candidate point cloud.

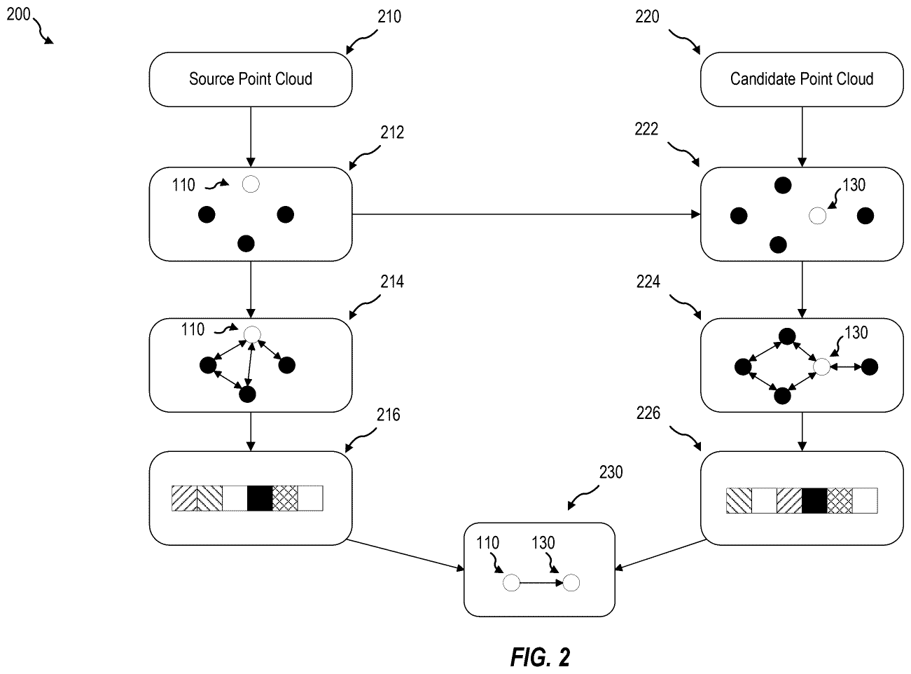

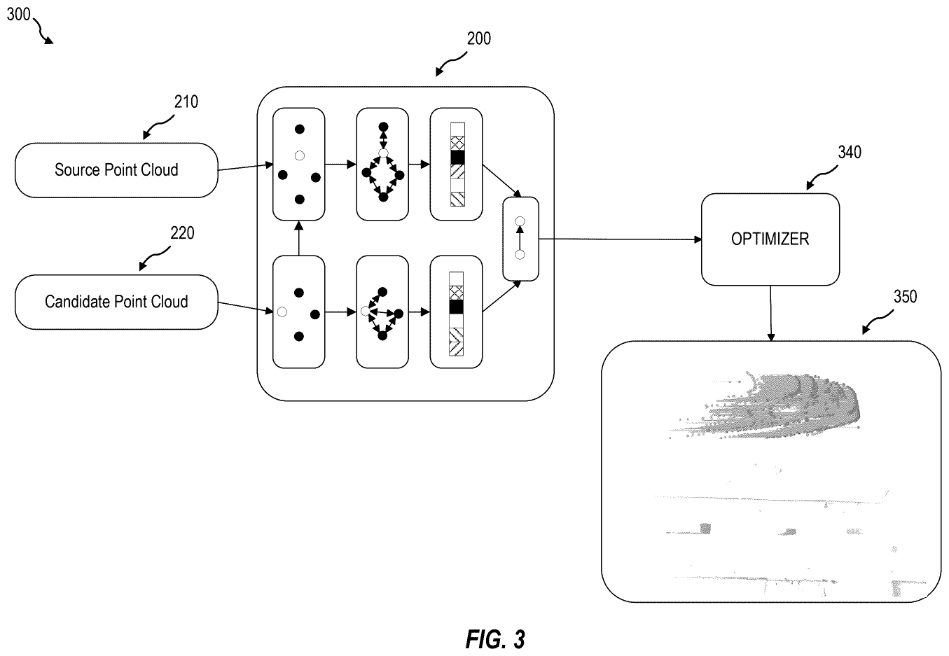

In certain aspects, a resulting flow field F having flow vectors f for each of the source points may be determined by optimizing the objective function. An objective function, for example Equation 2 discussed in more detail with respect to FIGS. 2 and 3, is constrained by the vector embeddings of the respective subgraphs created by the GNN based embedding model. The process of optimizing the objective function may be carried out using an AdamW optimizer for N number of iterations, which will be described further with respect to FIGS. 2 and 3.

FIG. 2 depicts an illustrative framework 200 for an example non-learning based scene flow estimation technique. The framework 200 will be described in the context of a vehicle traversing an environment as depicted in FIG. 1. However, this is only one example implementation. The framework 200 may be implemented for scene flow estimation of any suitable scene.

One or more sensors, radio detection and ranging equipment, light detection and ranging equipment, SONAR, or the like may be utilized to generate point clouds of an environment. In some aspects, the point clouds of the environment may be combined with data from one or more other sensor modalities such as image data through one or more sensor fusion techniques. In certain aspects, the point clouds are 3D data sets defining features of the environment.

A source point cloud 210 may be obtained during a first time frame (e.g., time t−1) and a candidate point cloud 220 may be obtained during a second time frame (e.g., time t). Aspects of the non-learning based scene flow estimation techniques described herein may group points of the point clouds (e.g., using nearest neighbor models), generate subgraphs of the grouped points, pass the subgraphs through a GNN based embedding model, such as GNNFlow, and determine corresponding matching points between the time-gapped point clouds by matching source vector embeddings and candidate vector embeddings generated by the GNN based embedding model.

At block 212, a point grouping process may be performed. In certain aspects, for each source point in the source point cloud a set of (e.g., neighboring) points are grouped together. In certain aspects, the grouping process may include identifying other source points that are within a fixed radius of a respective source point and grouping those points together. In some aspects, one or more KNN algorithms may be applied to each of the source points in the source point cloud to identify other source points to include in a grouping associated with the respective source point. As a result, each of the respective source points in the source point cloud may have a corresponding group of other source points defining respective source point groupings.

At block 214, subgraphs for each of the respective source point groupings may be formed. The subgraphs may be graphs which define a set of points in a metric space, where edges connecting the points indicate an attribute such as distance or relatedness of the points to each other.

For example, a point cloud P of N points may be defined as a set where P={p₁, . . . , p_{N}}, and each value {p₁, . . . , p_{N}} represents a point defined by 3D coordinates xᵢ∈R³ and, optionally, a state value sᵢ∈R^{k}. The state value sᵢ can encode properties such as reflected laser intensity and/or the previous flow values associated with the point. Given the point cloud P, for each point pᵢ, a subgraph G=(P, E) can be constructed by connecting associated (e.g., the K nearest) points, for example, but without limitation within a fixed radius r. E defines the edges between points and may be determined by Equation 2 shown below.

$$E = \{ ( {p}_{i} , {p}_{j} ) \vert {‖ {x}_{i} - {x}_{j} ‖}_{2} < r \}$$

Point pᵢ refers to the respective point, which is located at location xᵢ. The location xᵢ may be represented by 3D coordinate values, such as (x, y, z) or by another 3D coordinate system. The other point pⱼ is located at location xⱼ. The location xⱼ may be represented by 3D coordinate values, such as (x, y, z) or by another 3D coordinate system. An edge is defined for the pair of points (e.g., point pᵢ and point pⱼ) when the distance from point pᵢ to point pⱼ is less than a predefined distance (e.g., radius r).

In some aspects, the coordinate values (e.g., xᵢ and xⱼ), and optionally the state values sᵢ, and/or the previous flow vectors (vᵢ, vⱼ, v_{z}) are fed into the GNN based embedding model at block 216. The previous flow vectors (vᵢ, vⱼ, v_{z}) for a source point may be from a point in time prior to the first point in time corresponding to the source point. Each input may be represented as a node in the GNN based embedding model.

The edges may be formed using the Equation 2 above. In some aspects, the input can be multi-modal. For example, camera (RGB image data) and/or radar information may be included with the state value sᵢ.

At block 216, the non-learning based scene flow estimation technique may implement a GNN based embedding model, such as GNNFlow, to process each of the source subgraphs G₁ and generate corresponding source vector embeddings of dimension d for each respective source subgraph G₁.

The GNN based embedding model may be used to process the node features of the subgraphs. A layer of the GNN may be a multi-layer perceptron layer configured to aggregate features from a node's associated nodes (e.g., neighbors) to generate a feature vector. In certain aspects, this aggregation could be a sum, mean, or max operation, or the like. The initial layer of the GNN may take in the raw features and may begin the process of feature aggregation across the node's associated nodes. The process of feature aggregation may include blending local structural and feature information. Subsequent layers of the GNN may further process these features, for example increasing the “receptive field” so that higher layers capture information from a broader neighborhood.

The GNN may include a readout layer or a pooling layer that may be used to aggregate features from all the nodes in the subgraph to form a single embedding vector for the entire subgraph. This aggregation could again be a sum, mean, max, or even a more sophisticated pooling technique like global attention pooling, or the like. The result is a vector embedding (e.g., a source vector embedding) of dimension d that serves as the graph's embedding. The vector embedding may encapsulate the overall structure and node features of the subgraph.

At block 222, a point grouping process may be performed on the candidate point cloud. This is similar to the process discussed with reference to block 212. In certain aspects, for each candidate point in the candidate point cloud a set of associated (e.g., neighboring) points are grouped together. In certain aspects, the grouping process may include identifying other candidate points that are within a fixed radius of a respective candidate point and grouping those points together. In some aspects, one or more KNN algorithms may be applied to each of the candidate points in the candidate point cloud to identify other candidate points to include in a grouping the respective candidate point. As a result, each of the respective candidate points in the candidate point cloud may have a corresponding group of other candidate points defining respective candidate point groupings.

At block 224, subgraphs for each of the respective candidate point groupings may be formed. The subgraphs may be (e.g., nearest neighbor) graphs which define a set of points in a metric space, where edges connecting the points indicate an attribute such as distance or relatedness of the points to their neighboring points. The process at block 224 is similar to the process discussed with reference to block 214.

At block 226, which is similar to block 216, the non-learning based scene flow estimation technique may implement a GNN based embedding model, such as GNNFlow, to process each of the candidate subgraphs G₂ and generate corresponding candidate vector embeddings of dimension d for each respective candidate subgraph G₂.

At block 230, the source vector embeddings from block 216 and the candidate vector embeddings from block 226 are compared to determine corresponding point matching based on determining, for each source vector embeddings, a corresponding matching candidate vector embedding from the candidate vector embeddings. The process of determining the corresponding matching of two vector embeddings may be based on a comparison of distances between the source vector embedding and each of the candidate vector embeddings. In certain aspects, a minimum distance (or close to minimum distance) between a respective source vector embedding and a candidate vector embedding as compared to distances to other candidate vector embeddings may indicate the correspondence match of the two embedding vectors. Consequently, the respective source point and the respective candidate point, which correspond to the matched source vector embedding and candidate vector embedding, may be matched.

In certain aspects, analysis of the change in location of the matched source point to the matched candidate source point may indicate the flow vector and more broadly inform the scene flow field of the respective motion of the objects the points correspond to in the environment. In certain aspects, the correspondence point matchings and scene flow vectors for each of the source points may be obtained by following the objective function and related processes discussed with reference to FIG. 3.

FIG. 3 depicts an inference framework 300 for the non-learning based scene flow estimation techniques described herein. In certain aspects of the non-learning based scene flow estimation techniques described herein the optimization problem expressed in Equation 1 is constrained through the implementation of the GNN based embedding model, such as GNNFlow. The objective function may be expressed by Equation 3 below

$${F}^{*} = a r {g}_{F} min ( {λ}_{1} {\sum }_{{p}_{i} ∈ {P}_{t - 1}} d i s t ( {p}_{i} + {f}_{i} , {P}_{t} ) + {λ}_{2} {\sum }_{{p}_{i} ∈ {P}_{t - 1}} dist ( ∅ ( G {1}_{i} ) , ∅ ( G {2}_{τ ( i )} ) ) )$$

At block 340, through the optimization of the objective function, for example, by solving with an AdamW optimizer for M number of iterations, an optimal scene flow F* may be determined. In some aspects, M may be 10, 20, 30, 40, 50, 60, 70, 80, 90, 100 or any number between 1-100 or other experimentally determined value where convergence of the objective function may be achieved. For example, 100 iterations may consume about 0.35 seconds compared to other approaches which may take more than 1 second to converge.

The term dist(pᵢ+fᵢ, Pₜ) represents the Euclidean distance (or another appropriate metric) between the point pᵢ adjusted by the flow fᵢ, and its nearest point in Pₜ. In certain aspects, this term can ensure that the predicted scene flow aligns the points in a spatial context.

The term dist(Ø(G1ᵢ), Ø(G2_{τ(i)}) measures the distance between the embeddings of the subgraphs G1ᵢ and G2₍ᵢ₎, where G1ᵢ is the subgraph centered around pᵢ in Pₜ₋₁, and G2_{τ(i)} is the subgraph centered around the corresponding point τ(i) in Pₜ. Here, φ represents the GNN encoder function that generates the embeddings. In certain aspects, this term can ensure that the structural and contextual similarity between corresponding points is considered.

The terms λ₁ and λ₂ are weighting parameters that balance the importance of spatial alignment versus structural alignment. In certain aspects, tuning these parameters can optimize performance based on the specific requirements of the scene flow estimation task.

The term (i) refers to a mapping function that identifies the best matching target point in Pₜ for each source point pᵢ, based on the initial spatial alignment and refined by the embedding similarities.

At block 350, the framework 300 may generate one or more outputs. The one or more outputs may include scene flow vectors. The scene flow vectors may be output as a dataset or a visualization of the source point cloud and/or the candidate point cloud data appended with the scene flow vectors.

Certain aspects of the non-learning based scene flow estimation techniques described herein operate without the need for training or labeled datasets. In certain aspects, such techniques can function solely on inference, utilizing a predefined objective function to process any given input effectively. As discussed herein, in certain aspects, a GNN model such as GNNFlow introduces graph-based regularization as an objective function in scene flow estimation. Unlike a method that primarily depends on spatial relationships of 3D points using nearest neighbor techniques in coordinate frames or simple point embeddings, in certain aspects, a non-learning based scene flow estimation technique as discussed herein may leverage a graph-based structure. In certain aspects, such a graph-based structure efficiently encodes complex interactions, facilitating unsupervised correspondence matching with enhanced efficiency and accuracy.

Additionally, while existing learning algorithms typically utilize architectures such as multi-layer perceptron (MLPs), convolutional neural networks (CNNs), voxel-based networks, or point-based embedding networks for correspondence matching, none have harnessed a GNN-based embedding network to enhance the capability of matching correspondences.

Additionally, in certain aspects, a GNN, as discussed herein, can estimate scene flow by processing incomplete and intermittent sensor data from occluded or partially visible objects. This feature may provide a substantial advancement over other methods, which generally require complete visibility for accurate detection and tracking. In certain aspects, such non-learning based scene flow estimation techniques' ability to effectively utilize sparse and occluded data significantly enhances its applicability and performance in real-world scenarios.

Furthermore, in certain aspects, the utilization of GNN in non-learning based scene flow estimation may provide the capability of integrating multi-modal sensor data (e.g., LiDAR, radar, cameras) within a single graph node, creating a cohesive and unified graph representation of a scene. This approach may underscore the system's ability to amalgamate data from diverse sensors into a single model, improving the robustness and accuracy of scene flow estimation under varied environmental conditions.

In certain aspects, non-learning based scene flow estimation may be utilized for generating scene flow data that can support tasks such as object tracking, object position forecasting, object classification (e.g., classifying an object in an environment as static or dynamic), or other scenarios, for example, that autonomous vehicles or robots may encounter in environments. For example, scene flow estimation may be used in object tracking tasks such as tracking one or multiple objects in an environment based on the motion detected through scene flow estimation. Object-level movement and tracklet prediction (e.g., a fragment of a track followed by a moving object), can be obtained from scene flow estimations with matching algorithms configured to match old tracklets to new or predicted tracklets of objects in order to track an object's movement through an environment.

Non-learning based scene flow estimation may also be utilized for predicting a future position of an object. Scene flow estimations may be made over a period of time for a particular object. The addition of, or tracking of, the flow fields from one point in time to one or more subsequent points in time can provide a history of motion for an object. This history of motion can be used to generate one or more predicted future trajectories of the object. Predicted future trajectories of the object may be used by autonomous vehicles or robot devices to anticipate potential collisions between neighboring objects.

As a further example, non-learning based scene flow estimation may be used for classifying objects in an environment. One example classification problem is determining whether an object in an environment is a static object, such as a building, curb, or sign, or whether the object in the environment is a dynamic object such as a person, vehicle, animal, or the like. A scene flow estimation obtained through one or more of the non-learning based scene flow estimation techniques described herein may indicate whether a point corresponding to an object has a motion behavior. The motion behavior may be indicative as to whether the object is a static or dynamic object.

Additional uses of non-learning based scene flow estimation may include tracking an object through an occlusion. For example, a person crossing a street may become occluded by a vehicle or other object who may then reappear on the other side of an object causing the occlusion. Non-learning based scene flow estimation techniques described herein may enable a tracking of a point that is initially not occluded through an occlusion by carrying forward a scene flow field (e.g., comprising one or more flow vectors) associated with the object over a number of future points in time. In doing so, an estimation as to when the occluded object may reappear (e.g., become unoccluded) in the scene may be made such that non-learning based scene flow estimation can begin tracking the object in its not occluded state.

Furthermore, in a complex urban environment, an autonomous vehicle may be equipped with multiple sensor modalities, such as LiDAR, radar, and cameras. Each sensor may capture different aspects of the environment. For example, LiDAR may provide high-resolution 3D point clouds, radar may offer robustness under adverse weather conditions, and cameras may deliver rich textural information. With current scene flow processes there are challenges with estimating scene flow from this multimodal data, where each modality presents data in different formats and densities. Non-learning based scene flow estimation techniques that incorporate GNNFlow, however, may utilize its graph-based architecture to integrate and process multimodal data within a unified framework. By constructing a comprehensive graph that incorporates nodes representing each sensor's data, non-learning based scene flow estimation can leverage the complementary strengths of each modality. This integration enables non-learning based scene flow estimation to provide more accurate, robust, and context-aware scene flow estimations across diverse environmental conditions, outperforming other models that lack this multimodal integration capability.

### Example Operations

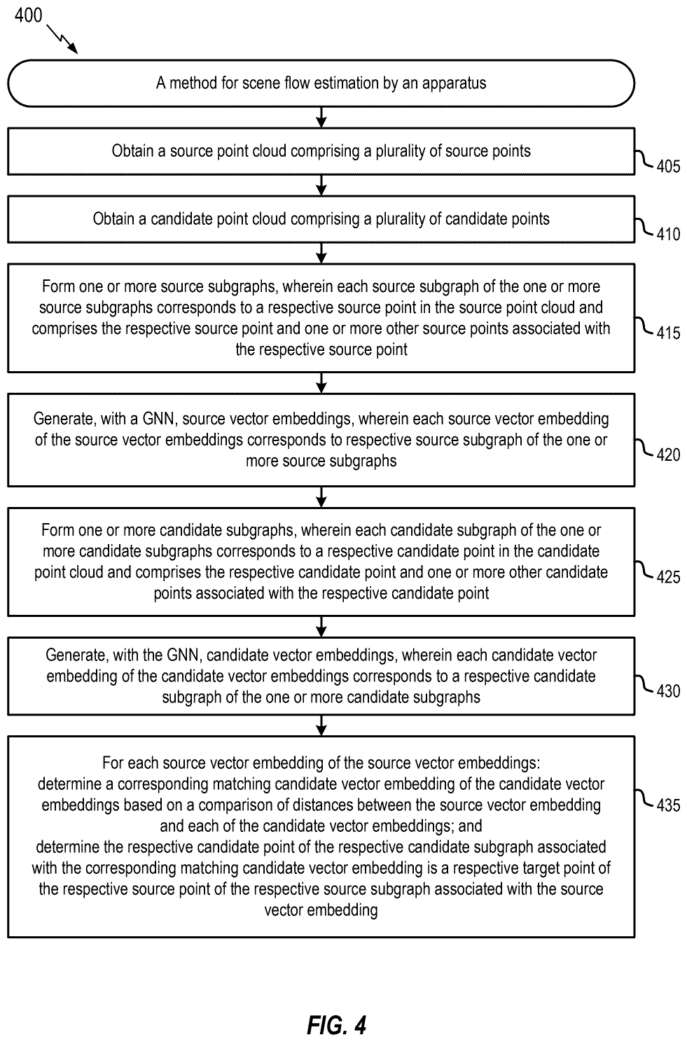

FIG. 4 shows an example method 400. Method 400 includes non-learning based scene flow estimation technique(s) and provides comparable or better performance than supervised learning-based scene flow estimation techniques without the technical challenges and labor-intensive and costly cultivation of large training datasets of annotated 3D point clouds associated with supervised learning-based scene flow estimation techniques. Additionally, in certain aspects, method 400 can provide accurate point correspondences between time-gapped frames for scene flow estimations. For example, method 400 may enable improved point correspondence performance for single and multiple modalities. Method 400 may utilize a graph-based structure that can efficiently encode complex interactions thereby facilitating unsupervised correspondence matching with enhanced efficiency and accuracy.

Method 400 begins at block 405 with obtaining a source point cloud comprising a plurality of source points. For example, the source point cloud may be the source point cloud 210 which may be obtained during a first time frame (e.g., time t−1) by the one or more sensors, radio detection and ranging equipment, light detection and ranging equipment, SONAR, or the like configured to generate point clouds of an environment.

Method 400 then proceeds to block 410 with obtaining a candidate point cloud comprising a plurality of candidate points. For example, the candidate point cloud may be the candidate point cloud 220 which may be obtained during a second time frame (e.g., time t) by the one or more sensors, radio detection and ranging equipment, light detection and ranging equipment, SONAR, or the like configured to generate point clouds of an environment.

Method 400 then proceeds to block 415 with forming one or more source subgraphs, wherein each source subgraph of the one or more source subgraphs corresponds to a respective source point in the source point cloud and comprises the respective source point and one or more other source points associated with the respective source point. For example, block 415 may correspond to blocks 212-214 as described with reference to FIG. 2.

Method 400 then proceeds to block 420 with generating, with a GNN, source vector embeddings, wherein each source vector embedding of the source vector embeddings corresponds to respective source subgraph of the one or more source subgraphs. For example, block 420 may correspond to the processes associated with block 216 as described with reference to FIG. 2.

Method 400 then proceeds to block 425 with forming one or more candidate subgraphs, wherein each candidate subgraph of the one or more candidate subgraphs corresponds to a respective candidate point in the candidate point cloud and comprises the respective candidate point and one or more other candidate points associated with the respective candidate point. For example, block 425 may correspond to the processes associated with blocks 222-224 as described with reference to FIG. 2.

Method 400 then proceeds to block 430 with generating, with the GNN, candidate vector embeddings, wherein each candidate vector embedding of the candidate vector embeddings corresponds to a respective candidate subgraph of the one or more candidate subgraphs. For example, block 430 may correspond to the processes associated with block 226 as described with reference to FIG. 2.

Method 400 then proceeds to block 435 with for each source vector embedding of the source vector embeddings: determining a corresponding matching candidate vector embedding of the candidate vector embeddings based on a comparison of distances between the source vector embedding and each of the candidate vector embeddings; and determining the respective candidate point of the respective candidate subgraph associated with the corresponding matching candidate vector embedding is a respective target point of the respective source point of the respective source subgraph associated with the source vector embedding. For example, block 435 may correspond to the processes associated with block 230 as described with reference to FIG. 2 and/or block 340 as described with reference to FIG. 3.

In one aspect, method 400 further includes generating, for each of the one or more source points of the plurality of source points, a respective scene flow vector based on a source point of the one or more source points and the respective target point of the source point. For example, the process of generating a respective scene flow vector based on a source point of the one or more source points and the respective target point of the source point may be accomplished by, for example, an AdamW optimizer as discussed with reference to block 340 depicted in FIG. 3.

In one aspect, for each of the one or more source points, generating the respective scene flow vector comprises optimizing an objective function constrained by a respective distance between the source vector embedding associated with the source point of the one or more source points and the candidate vector embedding associated with the respective target point of the source point.

In one aspect, method 400 further includes estimating an occluded candidate point for a first source point of the one or more source points based on the first source point and the respective scene flow vector of the first source point.

In one aspect, the GNN is a GNNFlow model.

In one aspect, the one or more other source points associated with the respective source point are k-nearest neighbors of the respective source point; and the one or more other candidate points associated with the respective candidate point are k-nearest neighbors of the respective candidate point.

In one aspect, the source point cloud and the candidate point cloud each comprise three-dimensional coordinates associated with state values.

In one aspect, the state values comprise at least one of: a reflected laser intensity, a previous flow value, or a color pixel value.

In one aspect, the one or more other source points associated with the respective source point are within a radius from the respective source point.

In one aspect, the one or more other candidate points associated with the respective candidate point are within a radius from the respective candidate point.

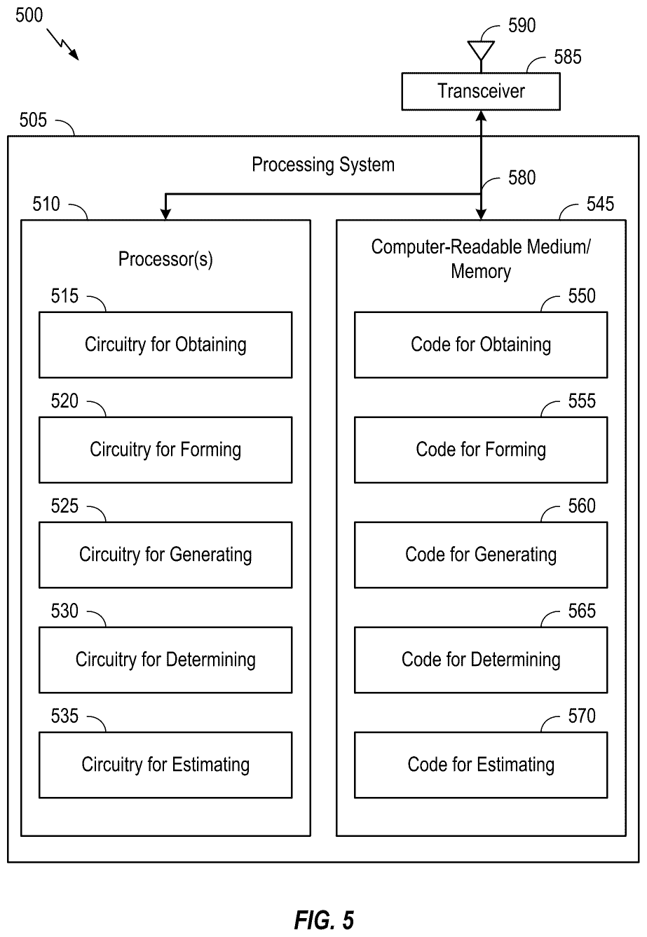

In one aspect, method 400, or any aspect related to it, may be performed by an apparatus, such as apparatus 500 of FIG. 5, which includes various components operable, configured, or adapted to perform the method 400. Apparatus 500 is described below in further detail.

Note that FIG. 4 is just one example of a method, and other methods including fewer, additional, or alternative operations are possible consistent with this disclosure.

### Example Apparatus

FIG. 5 depicts aspects of an example apparatus 500 configured for carrying out non-learning based scene flow estimation techniques. In some aspects, apparatus 500 is a computing device, such as a computing device of a vehicle or robot.

The apparatus 500 includes a processing system 505 coupled to a transceiver 585 (e.g., a transmitter and/or a receiver). The transceiver 585 is configured to transmit and receive signals for the apparatus 500 via an antenna 590, such as the various signals as described herein. The processing system 505 may be configured to perform processing functions for the apparatus 500, including processing signals received and/or to be transmitted by the apparatus 500.

The processing system 505 includes one or more processors 510 and a computer-readable medium/memory 545. In various aspects, the one or more processors 510 may be representative of the one or more processors of a computing device. The one or more processors 510 are coupled to a computer-readable medium/memory 545 via a bus 580. In some aspects, the computer-readable medium/memory 545 may be representative of the one or more memories of the computing device. The computer-readable medium/memory 545 is a non-transitory computer-readable medium/memory. In certain aspects, the computer-readable medium/memory 545 is configured to store instructions (e.g., computer-executable code), that when executed by the one or more processors 510, cause the one or more processors 510 to perform the method 400 described with respect to FIG. 4, the processes described with respect to FIGS. 2 and/or 3, or any aspect related to it, including any operations described in relation to FIGS. 2-4. Note that reference to a processor performing a function of apparatus 500 may include one or more processors performing that function of apparatus 500, such as in a distributed fashion.

In the depicted example, computer-readable medium/memory 545 stores code (e.g., executable instructions), including code for obtaining 550, code for forming 555, code for generating 560, code for determining 565, and code for estimating 570. Processing of the code 550-570 may enable and cause the apparatus 500 to perform the method 400 described with respect to FIG. 4, the processes described with respect to FIGS. 2 and/or 3, or any aspect related to it.

The one or more processors 510 include circuitry configured to implement (e.g., execute) the code stored in the computer-readable medium/memory 545, including circuitry for obtaining 515, circuitry for forming 520, circuitry for generating 525, circuitry for determining 530, and circuitry for estimating 535. Processing with circuitry 515-535 may enable and cause the apparatus 500 to perform the method 400 described with respect to FIG. 4, the processes described with respect to FIGS. 2 and/or 3, or any aspect related to it.

More generally, means for communicating, transmitting, sending or outputting for transmission may include one or more transceivers 585 and/or one or more antenna 590 of the apparatus 500 in FIG. 5, and/or one or more processors 510 of the apparatus 500 in FIG. 5. Means for communicating, receiving or obtaining may include the one or more transceivers 585 and/or one or more antenna 590 of the apparatus 500 in FIG. 5, and/or one or more processors 510 of the apparatus 500 in FIG. 5.

### Example Clauses

Implementation examples are described in the following numbered clauses:

Clause 1: A method comprising: obtaining a source point cloud comprising a plurality of source points; obtaining a candidate point cloud comprising a plurality of candidate points; forming one or more source subgraphs, wherein each source subgraph of the one or more source subgraphs corresponds to a respective source point in the source point cloud and comprises the respective source point and one or more other source points associated with the respective source point; generating, with a GNN, source vector embeddings, wherein each source vector embedding of the source vector embeddings corresponds to respective source subgraph of the one or more source subgraphs; forming one or more candidate subgraphs, wherein each candidate subgraph of the one or more candidate subgraphs corresponds to a respective candidate point in the candidate point cloud and comprises the respective candidate point and one or more other candidate points associated with the respective candidate point; generating, with the GNN, candidate vector embeddings, wherein each candidate vector embedding of the candidate vector embeddings corresponds to a respective candidate subgraph of the one or more candidate subgraphs; for each source vector embedding of the source vector embeddings: determine a corresponding matching candidate vector embedding of the candidate vector embeddings based on a comparison of distances between the source vector embedding and each of the candidate vector embeddings; and determining the respective candidate point of the respective candidate subgraph associated with the corresponding matching candidate vector embedding is a respective target point of the respective source point of the respective source subgraph associated with the source vector embedding.

Clause 2: The method of Clause 1, further comprising: generating, for each of the one or more source points of the plurality of source points, a respective scene flow vector based on a source point of the one or more source points and the respective target point of the source point.

Clause 3: The method of Clause 2, wherein, for each of the one or more source points, generating the respective scene flow vector comprises optimizing an objective function constrained by a respective distance between the source vector embedding associated with the source point of the one or more source points and the candidate vector embedding associated with the respective target point of the source point.

Clause 4: The method of Clause 2, further comprising estimating an occluded candidate point for a first source point of the one or more source points based on the first source point and the respective scene flow vector of the first source point.

Clause 5: The method of any one of Clauses 1-4, wherein the GNN is a GNNFlow model.

Clause 6: The method of any one of Clauses 1-5, wherein: the one or more other source points associated with the respective source point are k-nearest neighbors of the respective source point; and the one or more other candidate points associated with the respective candidate point are k-nearest neighbors of the respective candidate point.

Clause 7: The method of any one of Clauses 1-6, wherein the source point cloud and the candidate point cloud each comprise three-dimensional coordinates associated with state values.

Clause 8: The method of Clause 7, wherein the state values comprise at least one of: a reflected laser intensity, a previous flow value, or a color pixel value.

Clause 9: The method of any one of Clauses 1-8, wherein the one or more other source points associated with the respective source point are within a radius from the respective source point.

Clause 10: The method of any one of Clauses 1-9, wherein the one or more other candidate points associated with the respective candidate point are within a radius from the respective candidate point.

Clause 11: One or more apparatuses, comprising: one or more memories comprising executable instructions; and one or more processors configured to execute the executable instructions and cause the one or more apparatuses to perform a method in accordance with any one of Clauses 1-10.

Clause 12: One or more apparatuses configured for wireless communications, comprising: one or more memories; and one or more processors, coupled to the one or more memories, configured to cause the one or more apparatuses to perform a method in accordance with any one of Clauses 1-10.

Clause 13: One or more apparatuses configured for wireless communications, comprising: one or more memories; and one or more processors, coupled to the one or more memories, configured to perform a method in accordance with any one of Clauses 1-10.

Clause 14: One or more apparatuses, comprising means for performing a method in accordance with any one of Clauses 1-10.

Clause 15: One or more non-transitory computer-readable media comprising executable instructions that, when executed by one or more processors of one or more apparatuses, cause the one or more apparatuses to perform a method in accordance with any one of Clauses 1-10.

Clause 16: One or more computer program products embodied on one or more computer-readable storage media comprising code for performing a method in accordance with any one of Clauses 1-10.

Clause 17: One or more apparatuses configured for wireless communications, comprising: a processing system that includes one or more processors and one or more memories coupled with the one or more processors, the processing system configured to cause the one or more apparatuses to perform a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain a source point cloud comprising a plurality of source points;
obtain a candidate point cloud comprising a plurality of candidate points;
form one or more source subgraphs, wherein each source subgraph of the one or more source subgraphs corresponds to a respective source point in the source point cloud and comprises the respective source point and one or more other source points associated with the respective source point;
generate, with a graph neural network (GNN), source vector embeddings, wherein each source vector embedding of the source vector embeddings corresponds to respective source subgraph of the one or more source subgraphs;
form one or more candidate subgraphs, wherein each candidate subgraph of the one or more candidate subgraphs corresponds to a respective candidate point in the candidate point cloud and comprises the respective candidate point and one or more other candidate points associated with the respective candidate point;
generate, with the GNN, candidate vector embeddings, wherein each candidate vector embedding of the candidate vector embeddings corresponds to a respective candidate subgraph of the one or more candidate subgraphs; and
for each source vector embedding of the source vector embeddings:
determine a corresponding matching candidate vector embedding of the candidate vector embeddings based on a comparison of distances between the source vector embedding and each of the candidate vector embeddings; and
determine the respective candidate point of the respective candidate subgraph associated with the corresponding matching candidate vector embedding is a respective target point of the respective source point of the respective source subgraph associated with the source vector embedding.

2. The apparatus of claim 1, wherein the processing system is configured to cause the apparatus to: for each of one or more source points of the plurality of source points, generate a respective scene flow vector based on a source point of the one or more source points and the respective target point of the source point.

3. The apparatus of claim 2, wherein, for each of the one or more source points, to generate the respective scene flow vector the processing system causes the apparatus to optimize an objective function constrained by a respective distance between the source vector embedding associated with the source point of the one or more source points and the candidate vector embedding associated with the respective target point of the source point.

4. The apparatus of claim 2, wherein the processing system is configured to cause the apparatus to estimate an occluded candidate point for a first source point of the one or more source points based on the first source point and the respective scene flow vector of the first source point.

5. The apparatus of claim 1, wherein the GNN is a GNNFlow model.

6. The apparatus of claim 1, wherein:
the one or more other source points associated with the respective source point are k-nearest neighbors of the respective source point; and
the one or more other candidate points associated with the respective candidate point are k-nearest neighbors of the respective candidate point.

7. The apparatus of claim 1, wherein the source point cloud and the candidate point cloud each comprise three-dimensional coordinates associated with state values.

8. The apparatus of claim 7, wherein the state values comprise at least one of: a reflected laser intensity, a previous flow value, or a color pixel value.

9. The apparatus of claim 1, wherein the one or more other source points associated with the respective source point are within a radius from the respective source point.

10. The apparatus of claim 1, wherein the one or more other candidate points associated with the respective candidate point are within a radius from the respective candidate point.

11. An method of non-learning based scene flow estimation, the method comprising:
obtaining a source point cloud comprising a plurality of source points;
obtaining a candidate point cloud comprising a plurality of candidate points;
forming one or more source subgraphs, wherein each source subgraph of the one or more source subgraphs corresponds to a respective source point in the source point cloud and comprises the respective source point and one or more other source points associated with the respective source point;
generating, with a graph neural network (GNN), source vector embeddings, wherein each source vector embedding of the source vector embeddings corresponds to respective source subgraph of the one or more source subgraphs;
forming one or more candidate subgraphs, wherein each candidate subgraph of the one or more candidate subgraphs corresponds to a respective candidate point in the candidate point cloud and comprises the respective candidate point and one or more other candidate points associated with the respective candidate point;
generating, with the GNN, candidate vector embeddings, wherein each candidate vector embedding of the candidate vector embeddings corresponds to a respective candidate subgraph of the one or more candidate subgraphs; and
for each source vector embedding of the source vector embeddings:
determining a corresponding matching candidate vector embedding of the candidate vector embeddings based on a comparison of distances between the source vector embedding and each of the candidate vector embeddings; and
determining the respective candidate point of the respective candidate subgraph associated with the corresponding matching candidate vector embedding is a respective target point of the respective source point of the respective source subgraph associated with the source vector embedding.

12. The method of claim 11, further comprising: for each of one or more source points of the plurality of source points, generating a respective scene flow vector based on a source point of the one or more source points and the respective target point of the source point.

13. The method of claim 12, wherein the step of for each of the one or more source points, generating the respective scene flow vector further comprises optimizing an objective function constrained by a respective distance between the source vector embedding associated with the source point of the one or more source points and the candidate vector embedding associated with the respective target point of the source point.

14. The method of claim 12, further comprising estimating an occluded candidate point for a first source point of the one or more source points based on the first source point and the respective scene flow vector of the first source point.

15. The method of claim 11, wherein the GNN is a GNNFlow model.

16. The method of claim 11, wherein:
the one or more other source points associated with the respective source point are k-nearest neighbors of the respective source point; and
the one or more other candidate points associated with the respective candidate point are k-nearest neighbors of the respective candidate point.

17. The method of claim 11, wherein the source point cloud and the candidate point cloud each comprise three-dimensional coordinates associated with state values.

18. The method of claim 17, wherein the state values comprise at least one of: a reflected laser intensity, a previous flow value, or a color pixel value.

19. The method of claim 11, wherein the one or more other source points associated with the respective source point are within a radius from the respective source point.

20. One or more non-transitory computer-readable media comprising executable instructions that, when executed by one or more processors of an apparatus, cause the apparatus to perform operations comprising:
obtaining a source point cloud comprising a plurality of source points;
obtaining a candidate point cloud comprising a plurality of candidate points;
forming one or more source subgraphs, wherein each source subgraph of the one or more source subgraphs corresponds to a respective source point in the source point cloud and comprises the respective source point and one or more other source points associated with the respective source point;
generating, with a graph neural network (GNN), source vector embeddings, wherein each source vector embedding of the source vector embeddings corresponds to respective source subgraph of the one or more source subgraphs;
forming one or more candidate subgraphs, wherein each candidate subgraph of the one or more candidate subgraphs corresponds to a respective candidate point in the candidate point cloud and comprises the respective candidate point and one or more other candidate points associated with the respective candidate point;
generating, with the GNN, candidate vector embeddings, wherein each candidate vector embedding of the candidate vector embeddings corresponds to a respective candidate subgraph of the one or more candidate subgraphs; and
for each source vector embedding of the source vector embeddings:
determining a corresponding matching candidate vector embedding of the candidate vector embeddings based on a comparison of distances between the source vector embedding and each of the candidate vector embeddings; and
determining the respective candidate point of the respective candidate subgraph associated with the corresponding matching candidate vector embedding is a respective target point of the respective source point of the respective source subgraph associated with the source vector embedding.
